(19) United States
(12) Patent Application Publication
(10) Pub. No.: US 2012/0293086 A1
(43) Pub. Date: Nov. 22, 2012

(54) Light-Emitting Module and Luminaire

(75) Inventors: Toru ISHIKITA, Kanagawa-ken (JP); Hirokazu OTAKE, Kanagawa-ken (JP); Yoshiji KAMATA, Kanagawa-ken (JP); Takayoshi MORIYAMA, Kanagawa-ken (JP); Makoto YAMAZAKI, Kanagawa-ken (JP); Koji SUZUKI, Kanagawa-ken (JP); Shinichi KUMASHIRO, Kanagawa-ken (JP)

(73) Assignee: TOSHIBA LIGHTING & TECHNOLOGY CORPORATION, Yokosuka-shi (JP)

(21) Appl. No.: 13/424,962

(22) Filed: Mar. 20, 2012

(30) Foreign Application Priority Data
May 20, 2011 (JP) 2011-114222

(51) Int. Cl. H05B 37/02

(52) U.S. Cl. 315/201

(57) ABSTRACT

A light-emitting module in the embodiment includes a plurality of light-emitting elements, a power circuit, a power terminal, a feeding power terminal, and a substrate. The power circuit is configured to supply electric power to the light-emitting elements and performs lighting control. The power terminal is connected to the power circuit. The feeding power terminal is electrically connected to both ends of the power terminal. The substrate includes the plurality of light-emitting elements, the power circuit, the power terminal, and the feeding power terminal mounted thereon.

### CROSS-REFERENCE TO RELATED APPLICATIONS

This application is based upon and claims the benefit of priority from the prior Japanese Patent Application No. 2011-114222, filed on May 20, 2011; the entire contents of which are incorporated herein by reference.

### FIELD

Embodiments described herein relate generally to a light-emitting module using a light-emitting element such as an LED as a light source and a luminaire.

### BACKGROUND

Recently, in association with a tendency toward high power, high efficiency, and diffusion LEDs, luminaires which employ the LEDs as light sources, are configured to be used indoors and outdoors, and promise longer life are developed. Such luminaries are configured to obtain a predetermined amount of light with a plurality of LEDs mounted on a substrate and, for example, to achieve the lighting control of the LEDs by supplying a DC power from a power source device connected to a commercial utility AC power source.

In this case, a circuit substrate of the power source device and the substrate provided with the LEDs mounted thereon are configured as separate substrates.

Incidentally, a light emitting element such as the LED is subject to lowering of light output in association with increase in temperature thereof, and to shortening of the service life correspondingly. Therefore, luminaires having a solid light-emitting element such as the LED or an EL element as a light source is required to suppress temperature rise of the light-emitting element in order to elongate the service life or improve characteristics such as the light-emitting efficiency, and hence has a thermal problem.

In the case of the luminaire as described above, the circuit substrate of the cower source device and the substrate including the LEDs mounted thereon are the separate substrates. Therefore, there is tendency that a large number of components are required and hence the number of assembly steps increases, and a large storage space is required for these substrates.

In order to cope with a large variety of machine types, for example, when a light source unit is formed by connecting a plurality of substrates each provided with the LED mounted thereon, an electrical connection between the substrates including the LED mounted thereon and an electrical connection with the power source device are required. Therefore, electric wiring becomes complicated and, in addition, there may arise a need to re-design due to electric and thermal problems.

In view of such circumstances, it is an object of the invention to provide a light-emitting module including a power circuit and a light-emitting element disposed on the same substrate to simplify the configuration, configured to allow completion of lighting control of the light-emitting element in a single light-emitting module and allow easy connection of a plurality of pieces, and a luminaire having such a light-emitting module.

### DESCRIPTION OF THE DRAWINGS

FIG. 1 is a perspective view illustrating a state in which a luminaire according to a first embodiment is attached to an attachment member;

FIG. 2 is a perspective view illustrating the same luminaire in an exploded state;

FIG. 3 is a lateral cross-sectional view taken along a line X-X in FIG. 1;

FIG. 4 is a vertical cross-sectional view taken along a line Y-Y in FIG. 1;

FIG. 5 is a perspective view illustrating assembling steps of the same luminaire;

FIG. 6 is a perspective view illustrating a light-emitting module in the same luminaire;

FIG. 7 is a vertical cross-sectional view illustrating a case where a plurality of the same luminaires coupled in the longitudinal direction;

FIG. 8 is a plan view illustrating a state of arrangement of light-emitting elements with a first cover, a second cover, and an optical component demounted therefrom when the plurality of luminaires are coupled in the longitudinal direction in the same manner;

FIG. 9 is a wiring diagram illustrating a connected state of the light emitting modules when the plurality of luminaires are coupled in the longitudinal direction;

FIG. 10 is a wiring diagram illustrating a connected state of the light emitting modules in a modification in which the plurality of luminaires are coupled in the longitudinal direction; and

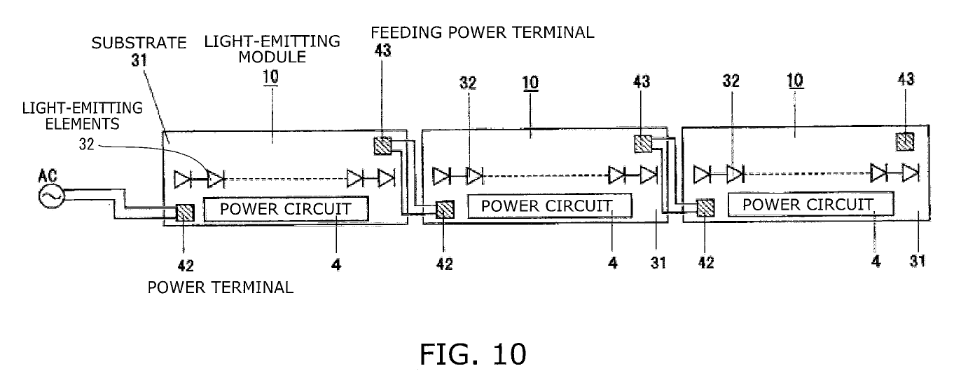

FIG. 11 is a lateral cross-sectional view illustrating a luminaire according to a second embodiment corresponding to FIG. 3.

### DETAILED DESCRIPTION

A light-emitting module in the embodiment includes a plurality of light-emitting elements, a power circuit, a power terminal, a feeding power terminal, and a substrate. The power circuit is configured to supply electric power to the light-emitting elements and performs lighting control. The power terminal is connected to the power circuit. The feeding power terminal is electrically connected to both ends of the power terminal. The substrate includes the plurality of light-emitting elements, the power circuit, the power terminal, and the feeding power terminal mounted thereon.

A luminaire according to another embodiment includes a plurality of light-emitting modules. The plurality of light-emitting modules are arranged in the longitudinal direction. The respective light-emitting modules each include a plurality of light-emitting elements, a power circuit, a power terminal, a feeding power terminal, and a substrate. The power circuit is configured to supply electric power to the light-emitting elements and performs the lighting The power terminal is connected to the power circuit. The feeding power terminal is electrically connected to both ends of the power terminal. The substrate includes the plurality of light-emitting elements, the power circuit, the power terminal, and the feeding power terminal mounted thereon. The power terminal of one of the light-emitting modules in the adjacent light-emitting modules from among the plurality of light emitting modules and the feeding power terminal of the other light-emitting module are connected to each other.

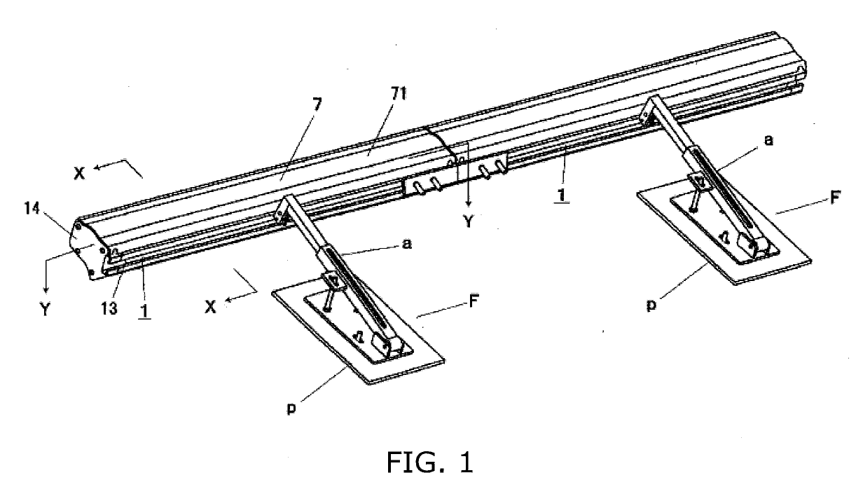

Referring now to FIG. 1 to FIG, 2, a first embodiment will be described. In respective drawings, the same parts are designated by the same reference numerals and overlapped descriptions are omitted.

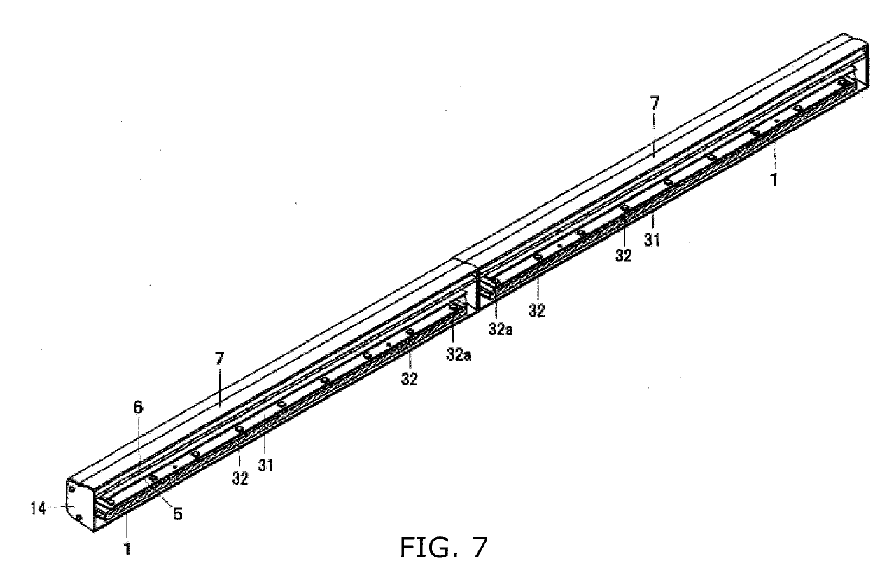

The first embodiment indicates a luminaire used mainly outdoors and suitable for creating a beautiful night view, for example for lighting up of an outer wall of a building. In FIG. 1, FIG. 7 to FIG. 9, modes of coupling two of the luminaires in the longitudinal direction are illustrated.

As illustrated in FIG. 1, the luminaires are configured. to be supported via attachment to attachment members F to be fixed to a structure such as a building. The attachment members F each are provided with a seat p and an arm a. The seat p is a portion to be fixed to the structure, and the arm a is configured to support the luminaire by attaching the same on a distal end thereof. The arm a is rotatable about one end side as a supporting point, and is configured to be capable of changing the direction of light emitted from, the luminaire by adjusting an angle of rotation thereof when installing the luminare.

In FIG. 1 which illustrates the state in which the luminaires are attached to the attachment members F, light emitted from the luminaire is directed upward in the illustration.

The configuration of the attachment member F is not limited to the configuration as described above as long as being configured to be capable of attaching and supporting the luminaire. The number of pieces of the luminaires to be installed may be one or plural, and may be applied as needed according to an object to be irradiated.

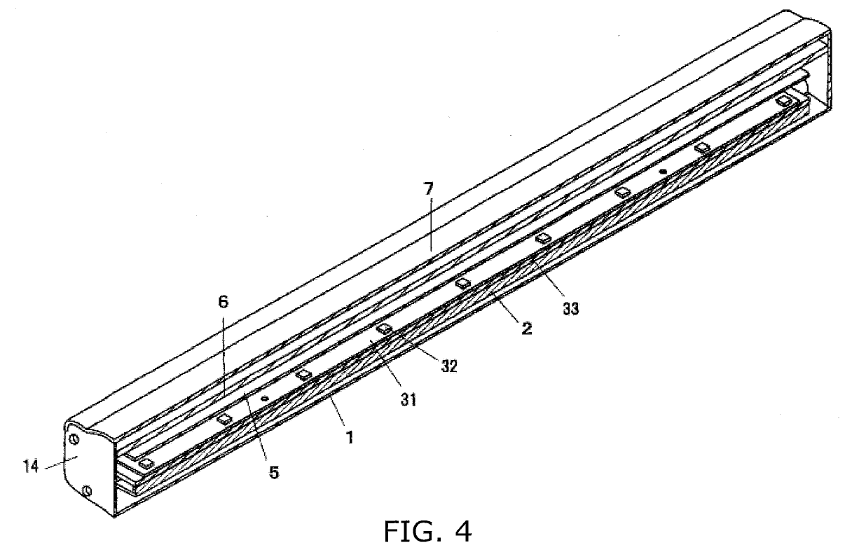

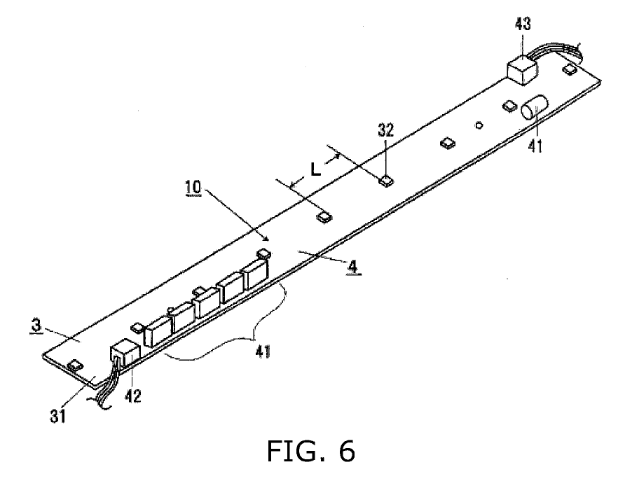

As illustrated in FIG. 1 to FIG. 6, the luminaire includes a case body 1, an inner case 2 stored inside the case body 1, a light source unit 3, a power circuit 4, an optical component 5 and a first cover 6 disposed on the front side of the light source unit 3 (the side in the direction of emission of light), and a second cover 7 disposed on the front side of the first cover 6.

The case body 1 is formed into a substantially cylindrical shape by extrusion using an aluminum material having a superior conductivity. More specifically, the case body 1 has a laterally elongated shape, is formed with a space which allows storage of the inner case 2, described later, on the inside of the substantially cylindrical shape, opened at both ends thereof in the longitudinal direction, and is formed with a rectangular opening 11 on the front side along the longitudinal direction.

Although the case body 1 is preferably formed by extrusion, a method of forming the case body 1 is not limited thereto. The molding method is not specifically limited.

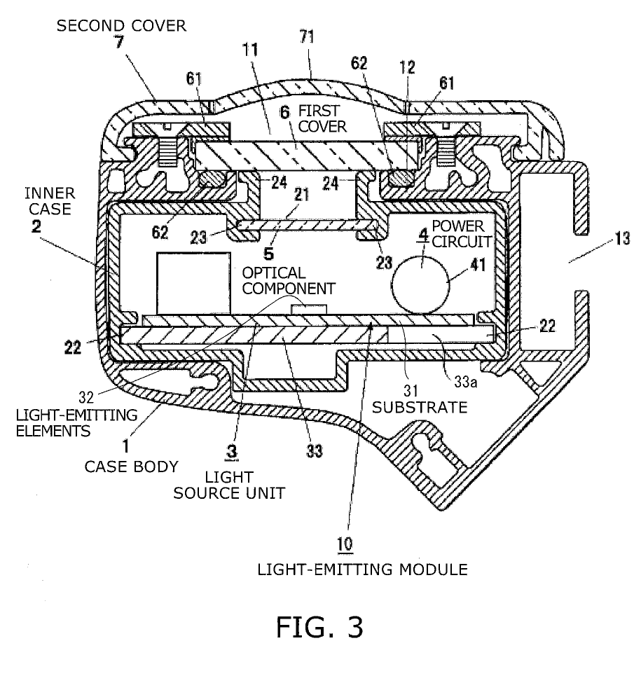

As shown in FIG. 3, a supporting portion 12 configured to support the first cover 6 is formed at an edge of the opening 11. The supporting portion 12 is formed with a groove-shaped portion along the longitudinal direction.

In addition, an attachment supporting portion 13, which is to be attached to the attachment member F, is formed on the side of an outer surface of a side wall of the case body 1. The attachment supporting portion 13 is formed along the longitudinal direction and has a C shape in a side view. An attachment rail, not described in detail, is inserted into the C-shaped attachment supporting portion 13, fixed to the attachment member F with bolts, so that the case body 1 is attached to and supported by the attachment member F.

Attached on both openings at the both ends in the longitudinal direction are end panel members 14 configured to close the openings.

The inner case 2 has a resin-made case having insulating properties. The inner case 2 is formed into a substantially cylindrical shape by extrusion in the same manner as the case body 1, has a laterally elongated shape, is opened at both ends thereof in the longitudinal direction, and is formed with an irradiation opening 21 along the longitudinal direction on a front surface. The inner case 2 is configured to be inserted and disposed in the space inside the case body 1 from the openings at the end.

As shown in FIG. 3 as a representative, the light source unit 3 and the optical component 5 are disposed inside the inner case 2. Therefore, the inner case 2 is formed with holding grooves 22 for the light source unit 3 on both side walls inside the inner case 2 along the longitudinal direction. Also, formed on both sides of the irradiation opening 21 at edge portions inside thereof along the longitudinal direction are holding grooves 23 for the optical component 5.

In addition, formed at the edge portions of the irradiation opening 21 are light-shielding louvres 24 projecting toward the front and then to both sides along the longitudinal direction. The light-shielding louvres 24 have a function to shield light emitted from the light source unit 3 and perform luminous intensity distribution control.

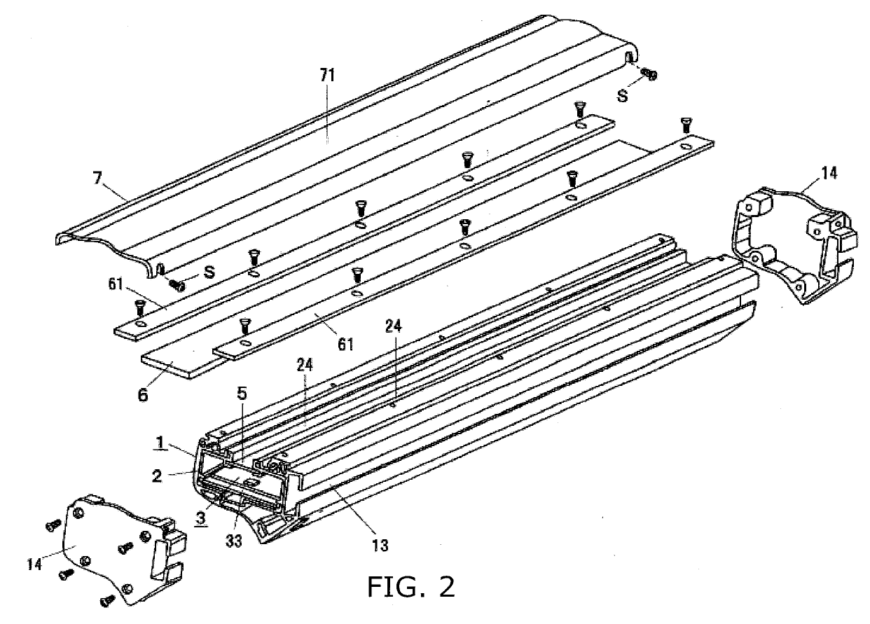

As shown in FIG. 2 to FIG. 6, the light, source unit 3 includes a substrate 31, and a plurality of light-emitting elements 32 mounted on the substrate 31. The light source unit 3 is disposed in the interior of the inner case 2 by being attached to a substrate attachment panel 33 having insulating properties and held in the holding grooves 22 of the inner case 2.

The substrate 31 is formed into a substantially. rectangular shape, and includes the plurality of light-elements 32 arranged and mounted thereon substantially linearly at predetermined intervals L in the longitudinal direction. In this case, the intervals between the adjacent light-emitting elements 32 are substantially equal and, more specifically, set to approximately 50 mm.

The substrate 31 is a flat plate formed of glass epoxy resin (FR-4) which is an insulating material, and a wiring pattern formed of copper foil is applied on a front surface. Also, a white resist layer is applied thereto as needed. When the insulating material is used as the material of the substrate 31, a glass composite substrate (CEM-3) or a ceramics material. may be applied. Furthermore, when using a metallic substrate, a metallic base substrate having an insulating layer laminated on one surface of a base plate superior in heat conductivity and superior in heat radiating properties such as aluminum may be applied.

The light-emitting elements 32 are each an LED and constitute a surface-mounted LED package. Schematically, the light-emitting element 32 includes an LED chip disposed on a main body formed of ceramics or a synthetic resin and a translucent resin for molding such as epoxy resin or silicone resin for sealing the LED chip.

The LED chip is an LED chip emitting blue light . The translucent resin is mixed with a fluorescent material, and a yellow fluorescent material which emits yellowish light which is in a compensating relationship with the blue light is used in order to allow emission of white right.

The LED may be configured by mounting a bear chip of the LED directly on the substrate 31, or by mounting a bombshell-shaped LED. A method or a form of mounting the LED is not specifically limited.

The power circuit 4 is provided on the substrate 31 which constitutes the power source unit 3. In other words, circuit components 41 such as a rectifier, a capacitor, and a resistive element which constitute the power circuit 4 are mounted on the substrate 31 of the light source unit 3. Therefore, the light-emitting elements 32 and the circuit components 41 are mounted on the same substrate 31.

More specifically, the circuit components 41 are preferably mounted on both sides or one side substantially along a linear row of the light-emitting elements 32, whereby a mounting area of the substrate 31 can be utilized effectively. In the first embodiment, the circuit components 41 are mounted on one side along the row of the light-emitting elements 32.

Since the plurality of light-emitting elements 32 and the power circuit 4 as described above are disposed on the same substrate 31 in this manner, the configuration is simplified, the number of components may be reduced, the number of assembly steps may be reduced, and a storage space of the substrate 31. may be reduced.

Also, disposed at one end of the substrate 31 in the longitudinal direction is a power terminal 42, and disposed at the other end at a position substantially on a diagonal line of the power terminal 42 is a feeding power terminal 43.

The substrate attachment panel 33 is formed with notches 33a, 33b respectively at a position in the longitudinal direction on the side where the power circuit 4 is arranged. and a position where the feeding power terminal 43 is disposed.

The power circuit 4 is connected to a commercial AC power source AC by a source line via the power terminal 42, and generates a DC power upon reception of the commercial AC power source AC. The power circuit 4 is, for example, configured by connecting a smoothing capacitor between output terminals of a full-wave rectifying circuit and connecting a DC voltage: converting circuit, and a current detecting unit to the smoothing capacitor. Therefore, the power circuit 4 is connected to the light-emitting elements 32 via the wiring pattern, and is configured to supply the DC power to the light-emitting elements 32 and perform the lighting control of the light-emitting elements 32.

The feeding power terminal 43 is electrically connected to both ends of the commercial AC power source AC, that is, both ends of the power terminal 42. Therefore, the power source can be supplied from the feeding power terminal 43. The connection of the feeding power terminal 43 to the both ends of the power terminal 42 may either be direct connection or indirect connection. Point of the configuration is that the power source can be supplied from the feeding power terminal 43.

As described above, in the first embodiment, a light-emitting module 10 includes the light source unit 3, the power circuit 4 disposed on the substrate 31 of the light source unit 3, the power terminal 12, and the feeding power terminal 43.

The optical component 5 is a prism sheet, and the prism sheet has translucency, formed into a narrow and elongated rectangular shape, and is disposed by being held in the holding grooves 23 of the inner case 2 at both ends thereof. Therefore, the prism sheet covers the irradiation opening 21 of the inner case 2, and is arranged on side of front surfaces of the light-emitting elements 32 corresponding to the row of the light-emitting elements 32.

The prism sheet is formed with fine grooves on a surface thereof and has a function to refract light emitted from the light-emitting elements 32 and diffuse the refracted light in the longitudinal direction.

As shown in FIG. 2 and FIG. 3, the first cover 6 has translucency and is a transparent glass plate having a rectangular shape. The glass plate is arranged so that both sides thereof on a back surface are placed on front end portions of the light-shielding louvres 24 formed on the inner case 2 and on the supporting portion 12 of the case body 1, and is fixed thereto so that both sides thereof on a front surface are pressed by a holding panel 61 from the front. The holding panel 61 is configured to be fixed to the front surface of the case body 1 by screwing.

Sealing members 62 having a circular shape in cross-section are disposed in the groove-shaped portions of the supporting portion 12 in a state of resiliently deformed by the pressure applied from the glass plate, and hence the opening 11 of the case body 1 is closed hermetically by the glass plate, whereby entry of moisture contents or dust into the interior thereof is prevented.

The second cover 7 is disposed on the front surface of the first cover 6, and is configured to cover the entire front surface including the first cover 6. A center portion 71 is curved so as to protrude toward the front side, and at least the center portion 71 has translucency.

Referring mainly to FIG. 2, FIG. 3, and FIG, 5, an example of an assembly step of the luminaire configured as described above will be described in brief below.

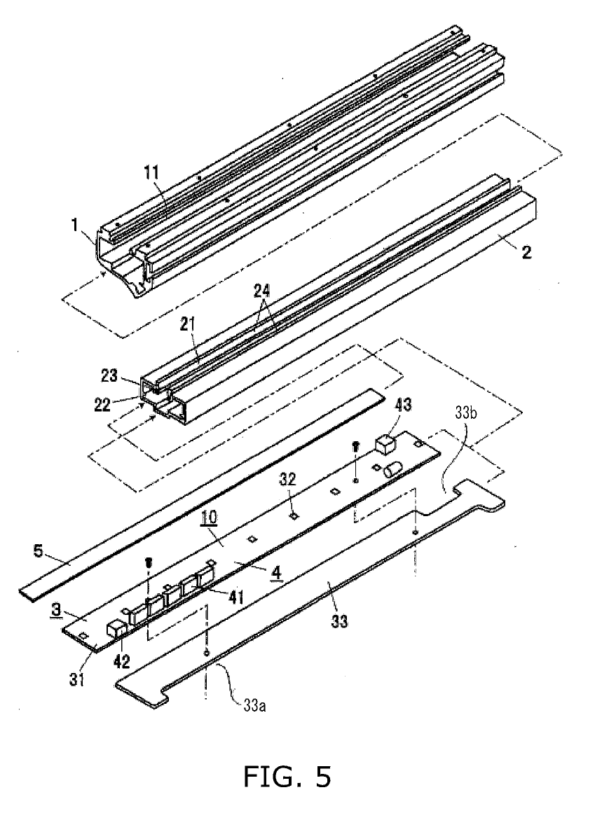

First of all, as shown in FIG. 5, the light-emitting module 10 attached to the substrate attachment panel 33 and the prism sheet as the optical component 5 are integrated into the inner case 2 and disposed thereon in this case, the substrate attachment panel 33 is inserted from one of the openings at the both ends thereof into the inner case 2 by sliding in the holding grooves 22 of the inner case 2. Also, the prism sheet is inserted by sliding into the holding grooves 23 of thinner case 2. Accordingly, the light-emitting module 10 and the optical component 5 are held in the insulative inner case 2.

Subsequently, the inner case 2 is disposed in the case body 1. More specifically, the inner case 2 is inserted by sliding into the space Inside the case body 1 from one of the openings at the both ends of the case body 1.

Subsequently, as shown in FIG. 2, the end panel members 14 are fixed to the openings at the both ends of the case body 1 with screws, then, as shown additionally in FIG. 3, the first. cower 6 is attached by securing the holding panel 61 from the front side so as to close the opening 11 of the case body 1 with screws.

Subsequently, the second cover 7 is arranged by sliding from one of the both ends of the case body 1 to the front side of the case body 1, and then attachment screws S are screwed into side walls of the end panel members 14 from the sides.

According to the luminaire assembled in this manner, the light-emitting module 10 and the optical component 5 can be assembled by inserting the same from the opening of the inner case 2 Also, since the inner case 2 in which the light-emitting module 10 and the optical component 5 are disposed can be assembled by inserting the same from the opening of the case body 1, the simplification of the assembly process is achieved.

Since the light-emitting module 10 is integrated into the resin case having insulating properties, which is the inner case 2, the insulating properties can be secured in a compact mode.

When power is supplied to the light-emitting module 10 via the power terminal 42 in the luminaire in an installed state, the power is distributed to the light-emitting elements 32 via the power circuit 4, and the respective light-emitting elements 32 are turned on. The light emitted from the light-emitting elements 32 passes through the prism sheet, which is the optical component 5, passes through the first cover 6 and the second. cover 7, and is directed to the intended direction.

In this case, since the light-emitting elements 32 are arranged at the intervals L in the longitudinal direction, the continuity of light in the longitudinal direction can hardly be secured. However, such a problem is resolved by the function of the optical component 5. In other words, light. emitted mainly from the light-emitting elements 32 straight. toward the front surface, once entered into the optical. component 5, is refracted in the longitudinal direction and proceeds so as to be diffused. In of words, the light emitted from the light-emitting elements 32 is diffused so as to extend in the longitudinal direction.

Therefore, even when there are the predetermined intervals L in the row of the light-emitting elements 32, disconnection of the continuity of light in the longitudinal direction is inhibited, and hence the continuity of the light is secured.

Also since the light-shielding louvres 24 are provided. at the edge portions of the irradiation opening 21, light emitted from the light-emitting elements 32 can hardly be recognized, and hence the appearance such that an irradiating surface is lighted uniformly is realized, so that the continuity of the light is secured further reliably.

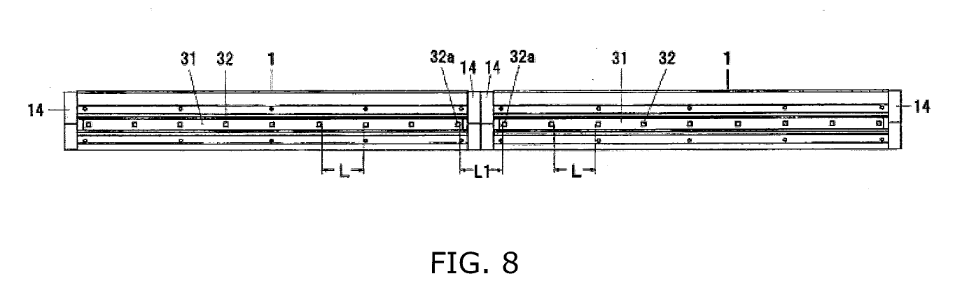

Furthermore, as shown in FIG. 7 and FIG. 8, in a case where a plurality of (two luminaires in the first embodiment) the luminaries are coupled in the longitudinal direction, a plurality of the light-emitting modules 10 are connected in a line in the longitudinal direction. In this case, an interval L1 between adjacent light-emitting elements 32a between the adjacent substrates 31 is set to be substantially the same as the interval L between the adjacent, light emitting elements 32 on the single substrate 31. More specifically, the interval L1 is set to approximately 50 mm, and is equal to the interval L.

Therefore, the securement of the continuity of light is expected also at a coupled portion between the luminaires, that is, at a boundary between the adjacent substrates 31 in the same manner as the continuity of the light in the longitudinal direction in the single substrate 31.

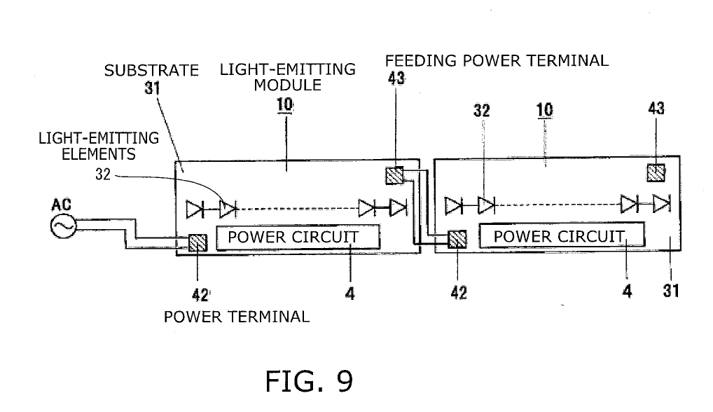

In this case, a wiring state as shown in FIG. 9 is assumed. In other words, the commercial AC power source AC as connected to the power terminal 42 in the light-emitting module 10 on the left side in the illustration. Therefore, power is supplied from the power terminal 42 to the power circuit 4, and DC power is supplied from the power circuit 4 to the light-emitting elements 32, whereby the lighting control of the light-emitting elements 32 is achieved.

Furthermore, the feeding power terminal 43 of the light-emitting module 10 is connected to the power terminal 42 in the light-emitting module 10 on the right side in the illustration. Therefore, in the light-emitting module 10 on the right side, power is supplied from the power terminal 42 to the power circuit 4, whereby the lighting control of the light-emitting elements 32 is achieved as well.

In this manner, the plurality of light-emitting modules 10, that is, the light-emitting module 10 on the left side and the light-Emitting module 10 on the right side are connected in parallel with the commercial AC power source AC, and power is supplied thereto respectively, and the lighting control of the light-emitting elements 32 is achieved.

The light-emitting module 10 includes the plurality of light-emitting elements 32 and the power circuit 4 configured to perform the lighting control thereof, therefore the lighting control of the light-emitting elements 32 is completed in the single light-Emitting module 10 without using a power source device (power circuit) configured separately. When connecting the plurality of light-emitting modules 10, a light-emitting module group can be configured by connecting the power terminal 42 and the feeding power terminal 43 of the adjacent light-emitting modules 10, and hence simple and easy connection is achieved.

Furthermore, the power terminal 42 is disposed at one end of the substrate 31 in the longitudinal direction and the feeding power terminal 43 is disposed at the other end of the substrate 31. Therefore, when arranging the substrates 31 in the longitudinal direction, and connecting between the power terminal 42 and the feeding power terminal 43, the distance between the power terminal 42 and the feeding power terminal 43 is short and hence the wiring length may be shortened, so that simplification of wiring is achieved.

As shown in FIG. 9, in a mode in which three of the light-emitting modules 10 are arranged and connected in the longitudinal direction in a line, the same effects as described above are achieved.

In the first embodiment, although the configuration in which the plurality of luminaires are coupled in the longitudinal direction, and the plurality of light-emitting modules 10 are disposed by arranging in the longitudinal direction has been described, the embodiment is also applicable to a case of disposing and arranging the plurality of light-emitting modules 10 in the longitudinal direction in a single luminaire.

As described above, according to the first embodiment, since the power circuit 4 and the light-emitting elements 32 are disposed on the same substrate 31, a simple configuration is achieved, and the lighting control of the light-emitting elements 32 can be completed in the single light-emitting module 10. Connection of the plurality of light-emitting modules 10 is also facilitated.

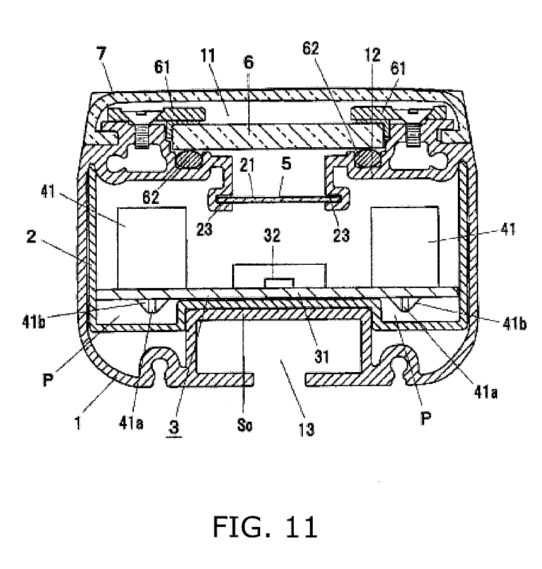

Referring now to FIG. 11, a second embodiment will be described. FIG. 11 shows a lateral cross-sectional view corresponding to FIG. 3 in the first embodiment. The same parts as in the first embodiment are designated by the same reference numerals and overlapped descriptions are omitted.

The second embodiment has basically the same configuration as the first embodiment. The plurality of light-emitting elements 32 and the power circuit 4 are disposed on the same substrate 31, and the power terminal 42 is disposed at one end of the substrate 31 in the longitudinal direction and the feeding power terminal 43 is disposed at the other end thereof.

A different point is that a space for securing the insulating properties of the substrate 31 is effectively used. More specifically, the substrate 31 includes the plurality of light-emitting elements 32 arranged and mounted in a substantially linearly at predetermined intervals in the longitudinal direction. Then, the circuit components 41 which constitute the power circuit 4 are mounted on both sides along a row of the light-emitting elements 32.

The light emitting element 32 is an LED and a surface-mounted LED package. The circuit components 41 include a through hole mount component. Therefore, a lead 41a penetrates from the front side to the back side through a through hole formed on the substrate 31, and a distal end thereof is fixed to the back side by a solder 41b.

Therefore, formed on the back side of the inner case 2 as a resin-made case having insulating properties are trough-shaped spaces P on both sides corresponding to portions of the solder 41b. In contrast, a center portion thereof is protruded toward the front and is configured to come into abutment with the back side of the substrate 31. In other words, a depressed space Sc is formed at the center portion.

Accordingly, components required for configuring the luminaire can be disposed in the space Sc. In the second embodiment, the attachment supporting portion 13 having a C-shape in a side view is disposed in the space Sc.

As described above, according to the second embodiment, since the space can be used effectively while securing the insulating properties in addition to the same effects as the first embodiment, the luminaire which can be reduced in size is provided.

The present invention is not limited to the configuration of the above-described embodiment, and various modifications may be made without departing the scope of the invention. For example, solid light-emitting elements such as the LEDs and organic ELs are applicable as the light-emitting element. Also, the number of light-emitting elements to be mounted is not specifically limited.

Furthermore, the luminaire is not limited to those used outdoors, and may be those used indoors. The invention is applicable to various luminaires used outdoors and indoors

Although several embodiments of the present invention have been described, these embodiments are shown only as examples and are not intended to limit the scope of the invention. These novel embodiments may be implemented in other various modes, and various omissions, replacements, and modifications may be made without departing the scope of the invention. These embodiments and the modifications are included in the scope and gist of the invention also in the scope of the invention as claimed in the appended claims and equivalents thereof.

What is claimed is:

1. A light-emitting module comprising:
a plurality of light-emitting elements;
a power circuit configured to supply power to the plurality of light-emitting elements to perform lighting control;
a power terminal connected to the power circuit;
a feeding power terminal electrically connected to both ends of the power terminal; and
a substrate including the plurality of light-emitting elements, the power circuit, the power terminal, and the feeding power terminal mounted thereon.

2. The module according to claim 1, wherein the plurality of light-emitting elements are arranged linearly at predetermined intervals in the longitudinal direction of the substrate.

3. The module according to claim 2, wherein the power circuit is disposed along a linear row of the plurality of light-emitting elements.

4. The module according to claim 3, wherein the power circuit is disposed on one side along the linear row of the plurality of light-emitting elements.

5. The module according to claim 3, wherein the power circuit is disposed on both sides along the linear row of the plurality of light-emitting elements.

6. The module according to claim 5, further comprising a case having insulating properties and provided on the substrate on a surface opposite from a surface having the plurality of light-emitting elements mounted thereon,
wherein a space is defined between a portion of the substrate opposite from a portion where the power circuit is mounted and the case.

7. The module according to claim 6, wherein the power circuit includes a through hole mount component.

8. The module according to claim 1, further comprising an optical component arranged on the front side of the plurality of light emitting elements and configured to diffuse light.

9. The module according to claim 1, wherein the substrate is formed into a laterally elongated shape, and the power terminal is disposed at one end of the substrate in the longitudinal direction, and the feeding power terminal is disposed at the other end of the substrate in the longitudinal direction.

10. The module according to claim 9, wherein the feeding power terminal is provided on a diagonal line of the power terminal.

11. A luminaire comprising: a plurality of light-emitting modules arranged in the longitudinal direction, wherein
each of the plurality of light-emitting modules includes:
a plurality of light-emitting elements;
a power circuit configured to supply power to the plurality of light-emitting elements to perform lighting control;
a power terminal connected to the power circuit;
a feeding power terminal electrically connected to both ends of the power terminal; and
a substrate including the plurality of light-emitting elements, the power circuit, the power terminal, and the feeding power terminal mounted thereon, and
the power terminal of one of the light-emitting modules in the adjacent light-emitting modules from among the plurality of light emitting modules and the feeding power terminal of the other light-emitting module are connected to each other.

12. The luminaire according to claim. 11, wherein the plurality of light-emitting elements are arranged linearly at predetermined intervals in the longitudinal direction of the substrate.

13. The luminaire according to claim 12, wherein the power circuit is disposed along a linear row of the plurality of light-emitting elements.

14. The luminaire according to claim 13, wherein the power circuit is disposed along one side of the linear row of the plurality of light-emitting elements.

15. The luminaire according to claim 13, wherein the power circuit is disposed along both sides of the linear row of the plurality of light-emitting elements.

16. The luminaire according to claim 15, further comprising a case insulating provided on the substrate on a surface opposite from a surface having the plurality of light-emitting elements mounted thereon,
wherein a space is defined between a portion of the substrate opposite from a portion where the power circuit is mounted and the case.

17. The luminaire according to claim 16, wherein the power circuit includes a through hole mount component.

18. The luminaire according to claim 11, further comprising an optical component arranged on the front side of the plurality of light-emitting elements and configured to diffuse light.

19. The luminaire according to claim 11, wherein the substrate is formed into a laterally elongated, shape, and the power terminal is disposed at one end of the substrate in the longitudinal direction, and the feeding power terminal is disposed at the other end of the substrate in the longitudinal direction.

20. The luminaire according to claim 19, wherein the feeding power terminal is provided on a diagonal line of the power terminal.
